(19) United States
(12) Patent Application Publication
(10) Pub. No.: US 2006/0253538 A1
(43) Pub. Date: Nov. 9, 2006

(54) Method and system for processing service triggering in internet protocol multimedia subsystem

(75) Inventors: Joon-Ho Jung, Suwon-si (KR); Deug-ku Chang, Yongin-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/416,080

(22) Filed: May 3, 2006

(30) Foreign Application Priority Data
May 3, 2005 (KR) 2005-37292

(51) Int. Cl. G06F 15/16

(52) U.S. Cl. 709/206; 709/227; 370/467

(57) ABSTRACT

A service triggering system and method for performing service triggering in an Internet protocol (IP) multimedia subsystem based on any message upon a call setup request in an IMS network are provided, in which a call session control function (CSCF) processes service triggering based on all messages, to which filter criteria (FC) information required for the service triggering is applied, upon a call setup, a home subscriber server (HSS) provides the filter criteria to the call session control function upon registration of a subscriber, an application server performs a call processing for providing a transcoding service, when an originating user equipment and a terminating user equipment use different codecs, and a media resource function performs a transcoding operation in accordance with different codecs between the originating user equipment and the terminating user equipment.

### CROSS-REFERENCE TO RELATED APPLICATIONS

This application claims the benefit under 35 U.S.C. 119(a) of a Korean Patent Application filed in the Korean Intellectual Property Office on May 3, 2005 and assigned Serial No. 2005-37292, the entire disclosure of which is hereby incorporated by reference.

### BACKGROUND OF THE INVENTION

1. Field of the Invention

The present invention relates to a method and system for processing service triggering in an Internet protocol (IP) multimedia subsystem. More particularly, the present invention relates to a method and system for processing service triggering which performs service triggering based on messages when a call setup is requested.

2. Description of the Related Art

In general, mobile communication systems, which provide circuit-based voice service, are classified into a frequency division multiple access (FDMA) scheme, time division multiple access (TDMA) scheme, and code division multiple access (CDMA) scheme according to each communication method. The FDMA scheme allows each subscriber to use a frequency channel allocated to himself/herself, by dividing a predetermined frequency band into a plurality of channels. The TDMA scheme allows a plurality of subscribers to use one frequency channel through time division. The CDMA scheme allows a plurality of subscribers to communicate using different codes allocated to the subscribers, while using the same frequency band at the same time.

With the rapid development of the mobile communication system (which is represented by the CDMA scheme) and Internet technologies, in order to meet the various demands of subscribers, the current mobile communication service provides a fast packet data service, which enables a mobile user equipment to transmit not only an E-mail and still picture but also a large amount of digital data, as well as conventional voice communication service. Accordingly, the mobile communication system is being developed from a circuit switched (CS) domain based on circuits to a packet-switched (PS) domain based on packets.

A core network (CN) providing multimedia service through the Internet is in the process of being changed from a conventional circuit-based CN to a packet-based CN, and further being developed to an IP-based CN. A communication system providing IP multimedia service (IM service) to subscribers through the IP-based CN is called an IP multimedia core network subsystem (IMS). In relation to a third generation partnership project (3GPP)/3rd generation partnership project 2 (3GPP2), various research is actively progressing to smoothly provide all IP service through the IMS.

The IMS includes a set of bearers and signaling related to network elements, and must cooperate with a web-based technology for voice, video, message data, and wireless subscribers. In addition, since the IMS provides packet data services of various types, based on IP transmission protocols, IMS users can transmit multimedia contents, such as a picture, video clip, sound clip, and the like, to each other through session-based messages.

Meanwhile, the current IMS provides a triggering scheme using filter criteria (FC). Herein, the “triggering” refers to a process wherein, when an originating user equipment requests a call setup, a serving-call session control function (S-CSCF) determines the type of service to be provided to the originating user equipment and transmits an INVITE message to an application server (AS) which provides the corresponding service.

FIG. 1 is a block diagram illustrating the construction of an IMS for the general service triggering.

The FC is part of a service profile for a specific subscriber, and is used as criteria for an S-CSCF 110 to determine the type of service to be provided to the subscriber when the subscriber requests a call setup. While the registration of a user equipment is proceeding, the FC is transmitted from a home subscriber server (HSS) 120 to the S-CSCF 110. Even after registration of the user equipment has been performed, the FC is transmitted from the HSS 120 as requested by the S-CSCF 110. The FC includes initial filter criteria (iFC) 140 and subsequent filter criteria (sFC) 150. The iFC 140 is used when the S-CSCF 110 performs service triggering based on an initial INVITE message transmitted from a user equipment. That is, the iFC 140 is used to check a specific header or parameter of the INVITE message and to determine an AS to which a corresponding message is to be transmitted. The sFC 150 is a kind of FC which is sent from a specific application server (for example, a session initiation protocol (SIP) Application Server/Open Service Access Service Capability Server/IP Multimedia-Service Switching Function (AS/OSA SCS/IM-SSF)) 130 to the S-CSCF 110 after the S-CSCF 110 starts cooperating with the AS 130 using the iFC 140. The sFC 150 enables the S-CSCF 110 to know how to process a session initiation protocol (SIP) message which is transmitted after the S-CSCF 110 starts cooperating with the AS 130.

Also, when a filtering and service triggering unit 111 of the S-CSCF 110, shown in FIG. 1, receives an initial INVITE message from a user equipment, the filtering and service triggering unit 111 performs a filtering operation with respect to the received message by using iFC 140 received from the HSS 120, determines if a specific service must be provided with respect to a corresponding call setup request, and requests an AS 130 which provides the corresponding service to set up a call. That is, the filtering and service triggering unit 111 of the S-CSCF 110 performs service triggering. A service platform trigger points 132 of the AS 130, which has received a call setup request, sends the sFC 150 to the S-CSCF 110 when the need arises, thereby notifying the S-CSCF 110 of the FC which is to be applied in order for the S-CSCF to provide a corresponding service. The S-CSCF 110 performs a message filtering operation by applying the sFC 150 to subsequent messages with respect to a corresponding call. In this case, a service logic 133 of the AS 130 determines if an INVITE message is to be processed. After determining that the INVITE message is to be processed, the service logic 133 creates a new INVITE message, and transmits the new INVITE message to a terminating user equipment through the S-CSCF 110. Also, when the service logic 133 receives a 606 Not Acceptable message representing that a codec transmitted from the originating user equipment is not acceptable, the service logic 133 determines if a multimedia resource function (MRF) which is to perform transcoding exists. When an MRF exists, the service logic 133 transmits the INVITE message to the MRF.

Meanwhile, in the IMS related standard of the current 3GPP, the iFC is defined with detailed specifications thereof, while the sFC 150 is presented only with its title. FIG. 2 is a block diagram illustrating a static model of a general user profile transmitted/received between an HSS and an S-CSCF. The iFC will now be described with reference to FIG. 2.

For example, blocks in a dotted line represent iFC 140 of a user profile. The iFC 140 includes information notifying the S-CSCF of an AS to access. In this case, the iFC 140 enables the S-CSCF to identify the AS which the S-CSCF is to access, by service points of interest 230 (that is, a trigger point 240) including a request Uniformed Resource Identifier (URI) 210, SIP method 212, SIP Header 214, session case 216, and session description 218.

In an exemplary implementation, the cooperation structure of IMS systems, to which the conventional triggering scheme is applied, will be described with reference to FIG. 3.

The important function elements of an IMS system for providing an IP multimedia (IM) service includes a servicing-call session control function (S-CSCF) 110 and a home subscriber server (HSS) 120. The S-CSCF 110 performs registration and multimedia call processing functions using a session initiation protocol (SIP) and a home subscriber server (HSS) 120. The HSS 120 performs both the mobility management and authorization of an IM-service user in relation to a home location register (HLR) of an existing mobile communication network.

The HSS 120 stores subscriber information and a service profile therein.

The S-CSCF 110 refers to a function provided by a call session control function, and performs an actual call setup or service setup with respect to a transmitted call setup request or service setup request.

Also, the S-CSCF 110 may exist as a separate network equipment, or may be integrated with a proxy call session control function (P-CSCF) and an interrogating call session control function (I-CSCF), which are defined in relation to IMS. The P-CSCF carries out registration and delivery of an outgoing/incoming call request from a visit network of a user to a home network of the user. The I-CSCF functions to select an S-CSCF suitable for a call request of a user among a plurality of S-CSCFs, and functions to prevent the configuration information of an S-CSCF, which is located in a home network, from being leaked to different networks for the purpose of maintaining security or the like.

The conventional service triggering procedure using iFC will now be described with respect to transcoding as an example. Transcoding is required when a user equipment located in an A IMS network 310 and a user equipment located in a B IMS network 320 communicate with each other, in which the originating-party IMS user equipment and the terminating-party IMS user equipment use different codecs. For instance, one of the user equipments uses a codec relating to voice, and the other user equipment uses a codec relating to video.

In step 301, an originating user equipment 100 transmits an INVITE message to an originating-party S-CSCF 110. In step 302, the originating-party S-CSCF 110 determines an AS to which the originating-party S-CSCF 110 is to access, based on iFC 140 transmitted from an HSS 120, and transmits an INVITE message to the determined AS 130. At this time, service triggering is performed. In steps 303 and 304, the originating-party S-CSCF 110 transmits the INVITE message to a terminating user equipment 101 through a terminating-party S-CSCF 111. Then, in steps 305 to 307, the terminating user equipment 101 transmits a 606 Not Acceptable message, representing that the terminating user equipment 101 cannot accept the codec information of the originating user equipment, to the AS 130 through the terminating-party S-CSCF 111 and originating-party S-CSCF 110. In step 308, an INVITE message (200 O.K. ACK) is transmitted/received between the AS 130 and a multimedia resource function (MRF) 131, which are connected through the originating-party S-CSCF 110. Thereafter, according to the typical procedure, the AS 130 transmits an INVITE message to the terminating user equipment 101, and then terminating user equipment 101 transmits a 183 session progress to the AS 130 in response to the INVITE message.

The S-CSCF 110 can perform service triggering only based on an initial INVITE message by means of the iFC. Also, the S-CSCF 110 transmits an INVITE message to a transcoding AS 130 which provides a service. Thereafter, the AS 130 transmits an INVITE message to the terminating user equipment 101, and then receives codec information from the terminating user equipment 01, so that a session is established between the MRF 131 and each user equipment.

Also, before a call flow as described above, a user profile must be downloaded from the HSS 120 to the S-CSCF 110 in advance. That is, the user profile must be transmitted from the HSS 120 to the S-CSCF 110 upon registration. In this case, the user profile transmitted from the HSS 120 must include the iFC 140, regardless of whether or not the terminating user equipment sends an acceptable codec list as a response.

FIGS. 4A, 4B and 5 are views for discretely explaining service triggering procedures for both cases wherein an acceptable codec list is sent from a terminating user equipment as a response and wherein such a codec is not sent.

First, the following description will be given to explain the case in which an acceptable codec list is sent from a terminating user equipment as a response, with reference to FIGS. 4A and 4B.

In step 401, an S-CSCF 110 receives an INVITE message from an originating user equipment 100 [Call-ID I]. In step 402, the S-CSCF 110 transmits a 100 Trying message to the originating user equipment 100. Thereafter, the transmission of the 100 Trying message is omitted. In step 403, the S-CSCF 110 transmits an INVITE message to an AS 130 based on information included in iFC 140. In step 404, a service logic 133 of the AS 130 determines if the INVITE message is to be processed. When a determination is made, the AS 130 creates a new INVITE message including codec information of the originating user equipment 100 and transmits the created INVITE message to a terminating user equipment 101 through the S-CSCF 110 in steps 405 and 406. In an exemplary implementation, a new dialog is created between the AS 130 and the terminating user equipment 101 [Call-ID 2]. In step 407, the terminating user equipment 101 transmits a 606 Not Acceptable message, in response to the INVITE message including the codec information of the originating user equipment 100. The 606 Not Acceptable message includes information representing that the codec transmitted from the originating user equipment 100 is not acceptable, and information regarding a codec which is acceptable by the terminating user equipment 101. In step 408, the S-CSCF 110 transmits an ACK message to the terminating user equipment 101 in order to end the dialog of Call-ID 2. In step 409, the S-CSCF 110 transmits the 606 Not Acceptable message to the AS 130. Then, in step 410, the service logic 133 of the AS 130 determines if an MRF 131, which is to perform transcoding, exists. When an MRF 131 exists, the AS 130 transmits an ACK message to the S-CSCF 110 in order to end the dialog of Call-ID 2 (step 411).

In step 412, the AS 130 transmits a new INVITE message to the MRF 131 through the S-CSCF 110 in order to establish a transcoding function for the terminating user equipment 101 [Call-ID 3].

In step 413, the AS 130 transmits a new INVITE message to the terminating user equipment 101 through the S-CSCF 110 in order to establish a session between the MRF 131 and the terminating user equipment 101 [Call-ID 4].

In step 414, the AS 130 transmits a new INVITE message to the MRF 131 through the S-CSCF 110 in order to establish a transcoding function for the originating user equipment 100 [Call-ID 5].

Step 415 refers to a typical IMS call flow. The AS 130 operates in a back-to-back user agent (B2BUA) mode, and provides a signaling conversion function betweens relevant dialogs.

Meanwhile, FIG. 5 is a flow diagram for explaining the case in which a terminating user equipment has not inserted a terminating-party codec into a 606 Not Acceptable message, so that codec negotiation is required. A description will be given below to explain when codec negotiation is required because the terminating user equipment has not inserted a terminating-party codec into a 606 Not Acceptable message, with reference to FIG. 5.

In step 501, an S-CSCF 110 receives an INVITE message from an originating user equipment 100 [Call-ID 1]. In step 502, the S-CSCF 110 transmits a 100 Trying message to the originating user equipment 100. In step 503, the S-CSCF 110 transmits an INVITE message to an AS 130 based on information included in iFC 140. In step 504, a service logic 133 of the AS 130 determines if the INVITE message is to be processed. When a determination is made, the AS 130 creates a new INVITE message and transmits the created INVITE message to a terminating user equipment 101 through the S-CSCF 110 in steps 505 and 506. In an exemplary implementation, a new dialog is created between the AS 130 and the terminating user equipment 101 [Call-ID 2]. In step 507, the terminating user equipment 101 transmits a 606 Not Acceptable message to the S-CSCF 110, in response to the INVITE message. The 606 Not Acceptable message includes information representing that the codec transmitted from the originating user equipment 100 is not acceptable, and information representing that information regarding a codec which is acceptable by the terminating user equipment 101 is not included (that is, there is no session description protocol (SDP)). In step 508, the S-CSCF 110 transmits an ACK message to the terminating user equipment 101 in order to end the dialog of Call-ID 2.

In step 509, the S-CSCF 110 transmits the 606 Not Acceptable message to the AS 130. In step 510, the service logic 133 of the AS 130 determines if an MRF 131, which is to perform transcoding, exists. When an MRF 131 exists, the AS 130 transmits an ACK message to the S-CSCF 110 in order to end the dialog of Call-ID 2 (step 511).

In step 512, the AS 130 transmits a new INVITE message to the MRF 131, in order to establish a transcoding function for the terminating user equipment 101 and simultaneously to obtain codec list information (SDP) supported by the MRF 131 [Call-ID 3].

In step 513, the AS 130 transmits a new INVITE message including a codec list, which has been provided from the MRF 131, to the terminating user equipment 101, in order to establish a session between the MRF 131 and the terminating user equipment 101 [Call-ID 4]. Then, the terminating user equipment 101 transmits an SDP including an acceptable codec list to the AS 130.

In step 514, a codec list selected by the terminating user equipment 101 is carried by a Provisional Response ACKnowledgement (PRACK) message transmitted from the AS 130 to the MRF 131, and information regarding a finally-selected codec is carried by a 200 OK message transmitted from the MRF 131 to the AS 130.

In step 515, the AS 130 transmits an ACK message to the MRF 131 through the S-CSCF 110 in order to end the dialog of Call-ID 3.

Thereafter, the following call setup procedure is same as the procedure which progresses after a 606 Not Acceptable message is received in the transcoding call flow of FIGS. 4A and 4B that shows the case in which a codec is presented by the terminating user equipment.

As described above, according to the service triggering method using the iFC and sFC provided in the IMS, it is possible, based on an initial message, to determine if a service is to be provided. Therefore, it is possible to request a desired service, upon an initial call setup request.

In addition, when a call setup is requested between originating/terminating user equipments in an IMS network, which can operate independently on an access network, it is possible to determine if the user equipments use different codecs, after an initial message is transmitted to the terminating user equipment and a response to the initial message is received. However, a problem exists in the conventional IMS network in that it is necessary to recognize that originating/terminating user equipments use different codecs and to request a transcoding service upon a call setup request.

Accordingly, there is a need for an improved method and system for processing service triggering in an internet protocol that recognizes the use of different codes in user equipments and requesting a transcoding service upon a call setup request.

### SUMMARY OF THE INVENTION

An aspect of exemplary embodiments of the present invention is to address at least the above problems and/or disadvantages and to provide at least the advantages described below. Accordingly, an aspect of exemplary embodiments of the present invention is to provide a method for processing service triggering in an IP multimedia subsystem, which can perform service triggering based on an initial INVITE message and all transmission messages transmitted after the initial INVITE message upon a call setup request in an IP multimedia core network subsystem (IMS) network.

Another object of exemplary embodiments of the present invention is to provide a method for processing service triggering in an IP multimedia subsystem, which provides a transcoding service in an IP multimedia core network subsystem (IMS) network.

To accomplish this object, in accordance with one aspect of exemplary embodiments of the present invention, there is provided a system for processing service triggering in an IP multimedia subsystem, in which a call session control function (CSCF) processes service triggering based on messages, to which filter criteria (FC) information required for the service triggering is applied, upon a call setup; a home subscriber server (HSS) provides the filter criteria to the call session control function upon registration of a subscriber; an application server performs a call processing for providing a transcoding service, when an originating user equipment and a terminating user equipment use different codecs; and a media resource function performs a transcoding operation with respect to different codecs between the originating user equipment and the terminating user equipment.

In accordance with another aspect of exemplary embodiments of the present invention, there is provided a method for processing service triggering in an IP multimedia subsystem, in which an INVITE message including codec information of an originating user equipment from the originating user equipment is received, by a call session control function, and the INVITE message is transmitted to a terminating user equipment; filter criteria are determined as being applied to a message, which includes information representing that the codec information of the originating user equipment is not acceptable and codec information of the terminating user equipment, when the message is received from the terminating user equipment; and a service is triggered by transmitting a new INVITE message to an application server, when the received message corresponds to a message to which filter criteria are applied.

In accordance with still another aspect of exemplary embodiments of the present invention, there is provided an apparatus for processing service triggering in a call session control function of an IP multimedia subsystem, in which a filtering and service triggering unit performs a filtering operation in accordance with a message by using filter criteria information transmitted from a home subscriber server when receiving the message during a call setup, and determines if it is necessary to provide a specific service with respect to a corresponding call setup request; and a service triggering counter increases a count value whenever service triggering is performed in order to restrict a number of service triggering times of the filtering and service triggering unit.

In accordance with another aspect of exemplary embodiments of the present invention, there is provided a method for processing service triggering in a call session control function of an IP multimedia subsystem, in which a service point trigger of a received message and filter criteria information received from a home subscriber server during a call setup are determined as being identical to each other; and a new INVITE message is created and transmitted to an application server, when the service point trigger of the received message and the filter criteria are identical to each other.

Other objects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other objects, features and advantages of certain exemplary embodiments of the present invention will be more apparent from the following detailed description taken in conjunction with the accompanying drawings, in which:

FIG. 1 is a block diagram illustrating the construction of an IMS for the general service triggering;

FIG. 2 is a block diagram illustrating a static model of a general user profile transmitted/received between an HSS and an S-CSCF;

FIG. 3 is a block diagram illustrating a static model of a typical user profile transmitted/received between an HSS and an S-CSCF;

FIGS. 4A, 4B are views for explaining service triggering control when a terminating user equipment transmits a 606 Not Acceptable message including a terminating-party codec;

FIG. 5 is a view for explaining service triggering control when a terminating user equipment transmits a 606 Not Acceptable message which does not include a terminating-party codec;

FIG. 6 is a block diagram illustrating the construction of a service triggering processing system in an IP multimedia subsystem according to an exemplary embodiment of the present invention;

FIG. 7 is a block diagram illustrating the construction of an IMS system for performing service triggering according to an exemplary embodiment of the present invention;

FIG. 8 is a block diagram illustrating a static model of a user profile transmitted/received between an HSS and an S-CSCF, to which the present invention is applied;

FIGS. 9A, 9B are views for explaining the service triggering control of an IMS, when a terminating user equipment transmits a 606 Not Acceptable message including a terminating-party codec according to an exemplary embodiment of the present invention;

FIG. 10 is a view for explaining the service triggering control of an IMS, when a terminating user equipment transmits a 606 Not Acceptable message which does not include a terminating-party codec according to an exemplary embodiment of the present invention; and

FIG. 11 is a flowchart illustrating the control operation of an S-CSCF, when the S-CSCF performs service triggering according to an exemplary embodiment of the present invention.

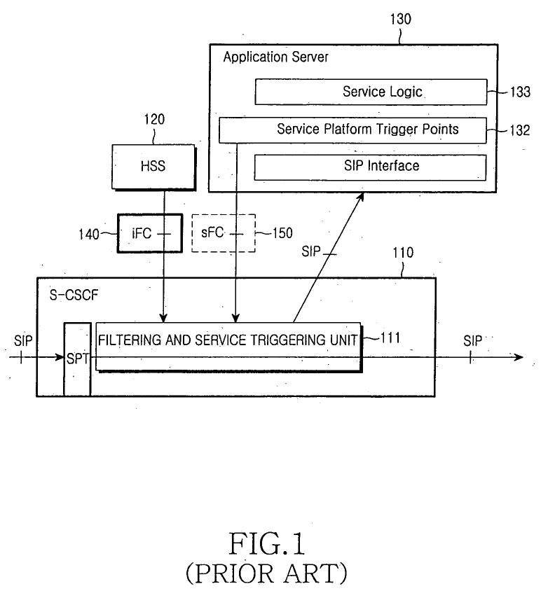

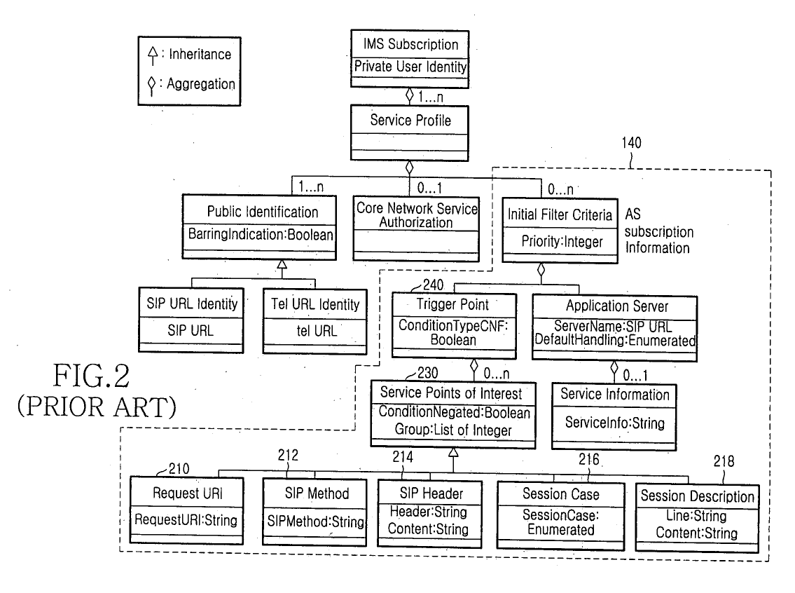

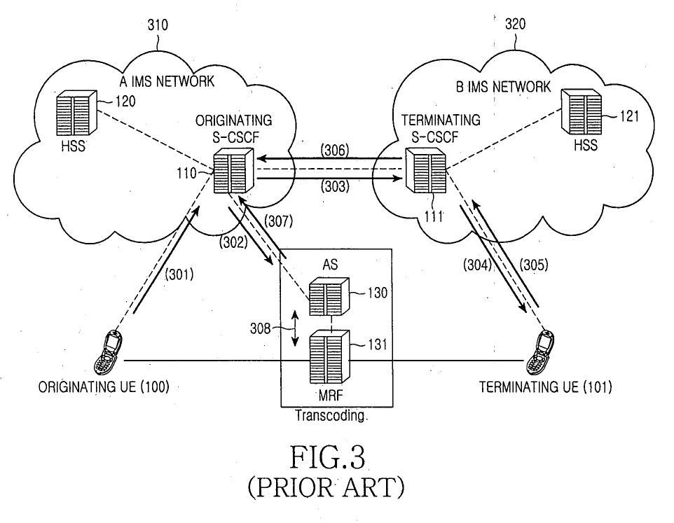

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

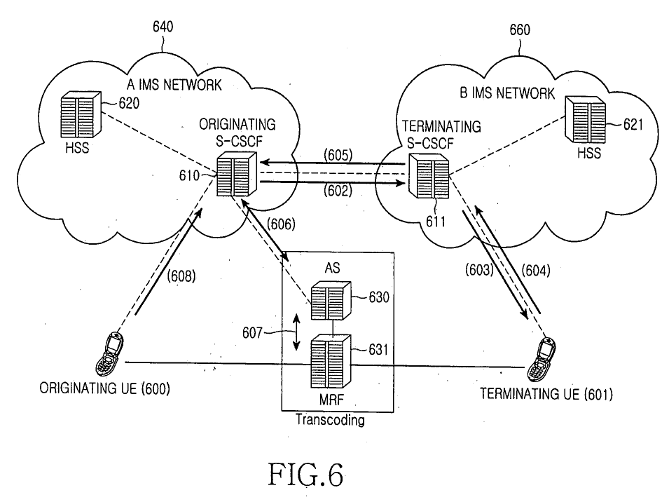

FIG. 6 is a block diagram illustrating the construction of a service triggering processing system in an IP multimedia subsystem according to an exemplary embodiment of the present invention. The service triggering processing system in an IP multimedia subsystem according to an exemplary embodiment of the present invention will now be described with reference to FIG. 6.

The service triggering processing system in the IP multimedia subsystem includes a serving-call session control function (S-CSCF) 610 and a home subscriber server (HSS) 620. The S-CSCF 610 performs multimedia call processing and registration using a session initiation protocol (SIP), and the HSS 620 performs both the mobility management and authorization of an IM-service user in relation to a home location register (HLR) of the existing mobile communication network.

When the S-CSCF 610 receives an initial INVITE message, the S-CSCF 610 transmits the INVITE message to an S-CSCF, in which a terminating user equipment is located, or to a serving system corresponding to an S-CSCF. Although the conventional S-CSCF performs service triggering based on an initial message by means of initial filter criteria (iFC), the S-CSCF 610 according to an exemplary embodiment of the present invention can perform service triggering based on an initial message and subsequently transmitted messages by means of any filter criteria (aFC).

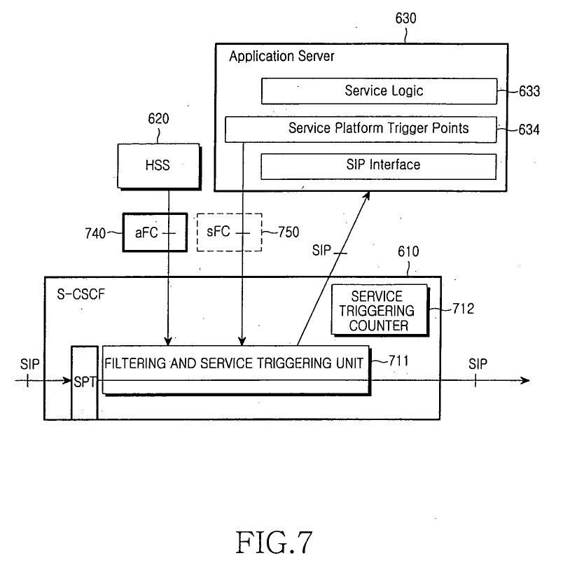

Also, the S-CSCF 610 must be able to recognize aFC when downloading a user profile from the HSS 620, and must be able to provide service triggering function based on an initial message and subsequently transmitted messages by means of aFC. In addition, when aFC is applied with respect to a plurality of messages among the total number of messages transmitted during a call setup, the S-CSCF 610 must be able to perform service triggering based on corresponding messages. The aFC will now be described in detail with respect to FIG. 7. FIG. 7 is a block diagram illustrating the construction of an IMS system for performing service triggering according to an exemplary embodiment of the present invention.

The S-CSCF 610 must be able to perform service triggering based on one specific message among a plurality of messages, and must be able to request a service to an application server (AS) 630 by creating a new INVITE message while operating in a back-to-back user agent (B2BUA) mode.

When aFC 740 and subsequent filter criteria (sFC) 750 are applied at the same time, the S-CSCF 610 must, according to their priorities, first process the FC having a higher priority.

The AS 630 performs a call processing operation for providing a transcoding service, selects a multimedia resource function (MRF) 631, which has a transcoding function, and requests the MRF 631 to perform the corresponding service. Since the AS 630 is a basic function for network cooperation, rather than a specific service, the AS 630 may be separately constructed, or may be constructed as a function unit for an internal service in an S-CSCF. Also, the AS 630 performs a call control function after the S-CSCF 610 performs service triggering based on a 606 Not Acceptable message.

The MRF (controller+processor) 631, which is a device for performing a transcoding function between different codecs, performs a transcoding operation as requested by the AS 630. Also, the MRF 631 has bearer connection between an originating user equipment 600 and a terminating user equipment 601, and performs a transcoding between the two user equipments.

The IMS user equipments 600 and 601 provide a Voice over Internet Protocol (VoIP) service based on SIP.

The HSSs 620 and 621 store subscriber information. Upon registration of a subscriber, the HSSs 620 and 621 provides the S-CSCF 610 with various information required for service triggering. According to an exemplary embodiment of the present invention, the HSSs 620 and 621 provide aFC information, in which the aFC includes service point triggers (SPTs) therein. The SPT includes criteria for triggering of a specific service, by means of an SIP method, existence of a specific header, contents of a specific header, information regarding a triggering time and the like. The prior art does not need information concerning when a service is to be triggered because iFC is used. However, certain exemplary embodiments of the present invention uses information regarding a triggering time because the S-CSCF 610 must perform service triggering based on an initial message and subsequently transmitted messages.

The existing service triggering procedure using aFC will now be described with respect to transcoding as an example. Transcoding is required when a user equipment located in an IMS network 640 of an A provider and a user equipment located in an IMS network 660 of a B provider communicate with each other, in which the originating IMS user equipment and the terminating-party IMS user equipment use different codecs.

In steps 602, 603, and 608 an originating user equipment 600 transmits an INVITE message to a terminating user equipment 601 through an originating-party S-CSCF 610 and a terminating-party S-CSCF 611. Then, in steps 604 and 605, the terminating user equipment 601 transmits a 606 Not Acceptable message, representing that the terminating user equipment 601 cannot accept the codec information of the originating user equipment 600, to the originating-party S-CSCF 610 through the terminating-party S-CSCF 611. In step 606, the originating-party S-CSCF 610 transmits an INVITE message to the AS 630. In step 607, an INVITE message (200 O.K. ACK) is transmitted/received between the AS 630 and the MRF 631, which are connected through the originating-party S-CSCF 610. Thereafter, the AS 630 transmits an INVITE message to the terminating user equipment 601, and then terminating user equipment 601 transmits a 183 session progress to the AS 630 in response to the INVITE message.

In order to apply a service triggering method according to an exemplary embodiment of the present invention, the S-CSCF 610 includes a filtering and service triggering unit 711 and a service triggering counter 712, as shown in FIG. 7. When receiving a message during a call setup, the filtering and service triggering unit 711 determines if a specific service for a corresponding call setup request is to be provided by filtering the message by means of aFC 740 transmitted from the HSS 620, and transmits a call setup request message to the AS 630 which provides the corresponding service. In an exemplary implementation, the S-CSCF 610 operates in a back-to-back user agent (B2BUA) mode, and must be able to create and transmit a new INVITE message to the AS 630. After receiving a call setup request, the AS 630 sends sFC 750 to the S-CSCF 610, thereby notifying the S-CSCF 610 of FC which is to be applied in order for the S-CSCF 610 to provide the corresponding. The S-CSCF 610 performs a message filtering operation with respect to subsequent messages during the corresponding call, based on the sFC 750. When the S-CSCF 610 processes a message transmitted after downloading the sFC 750 from the AS 630, the S-CSCF 610 must first apply the sFC 750 in order to process the message, and applies the aFC 740 provided from the HSS 620 when there is no matching FC in the sFC 750. Such levels of priority between the aFC 740 and sFC 750 may be determined by a provider.

Also, when the filtering and service triggering unit 711 of the S-CSCF 610 receives an initial INVITE message and subsequently transmitted messages, the filtering and service triggering unit 711 performs a filtering operation with respect to the received message by using aFC 740 received from the HSS 620, determines if a specific service is to be provided with respect to a corresponding call setup request, and requests the AS 630, which provides the corresponding service, to set up a call. That is, the filtering and service triggering unit 711 of the S-CSCF 610 performs service triggering. A service platform trigger points 634 of the AS 630, which has received a call setup request, sends the sFC 750 to the S-CSCF 610 when a need arises, thereby notifying the S-CSCF 610 of FC which is to be applied in order for the S-CSCF 610 to provide a corresponding service. The S-CSCF 610 performs a message filtering operation by applying the sFC 750 to subsequent messages with respect to a corresponding call. In an exemplary implementation, a service logic 633 of the AS 630 determines if an INVITE message is to be processed. After determining that the INVITE message is to be processed, the service logic 633 creates a new INVITE message, and transmits the new INVITE message to a terminating user equipment through the S-CSCF 610. Also, when the service logic 633 receives a 606 Not Acceptable message representing that a codec transmitted from the originating user equipment is not acceptable, the service logic 633 determines if an MRF 631, which is to perform transcoding, exists. When the MRF exists, the service logic 633 transmits an INVITE message to the MRF 631.

Meanwhile, the S-CSCF 610, according to an exemplary embodiment of the present invention can perform service triggering based on messages transmitted during a call setup by means of an SIP signaling protocol. However, if service triggering is performed based on transmitted messages, a call setup time period may be too long. Therefore, it is difficult to smoothly provide a corresponding service. In order to prevent such a problem, it is necessary to restrict the number of times that service triggering can be performed. Accordingly, the S-CSCF 610 includes the service triggering counter 712. The service triggering counter 712 increases the count value by one whenever service triggering is performed, and has an initial value of zero.

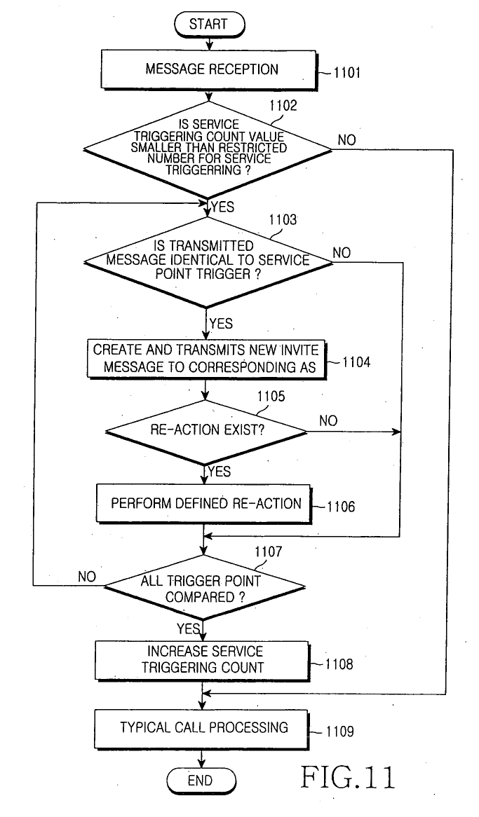

The operation of the S-CSCF 610 will later be described with reference to FIG. 11, in which the S-CSCF 610 performs a service triggering operation with the restricted number of times that service triggering can be performed.

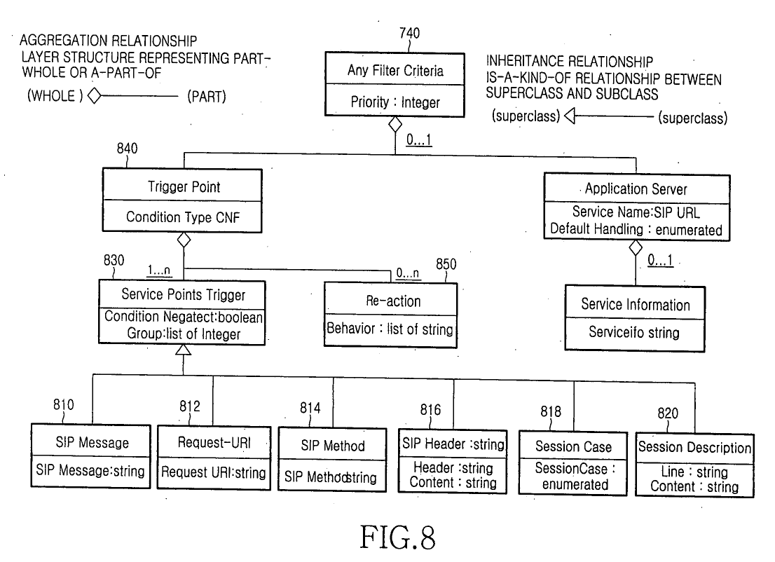

Meanwhile, the aFC 740 includes information regarding an AS to which the S-CSCF 610 is to access, as shown in FIG. 8. FIG. 8 is a block diagram illustrating a static model of a user profile transmitted/received between an HSS and an S-CSCF, according to an exemplary embodiment of the present invention. The aFC 740 will now be described with reference to FIG. 8.

The aFC 740 includes a service points trigger 830 (that is, a trigger point 840) which includes an SIP message 810, a request URI 812, an SIP method 814, an SIP Header 816, a session case 818, and a session description 820. The aFC 740 enables an S-CSCF to identify an AS which the S-CSCF is to access, and when service triggering is to be performed. In order to provide information for a time point for service triggering, which has not been provided in the conventional iFC, a specific SIP message 810 is defined to have the service point trigger 830. Also, since the aFC 740 allows the operation of the S-CSCF 610 to be changed depending on the specific SIP message 810, an additional operation of the S-CSCF 610 is defined by mapping re-action 850 on the service point trigger 830.

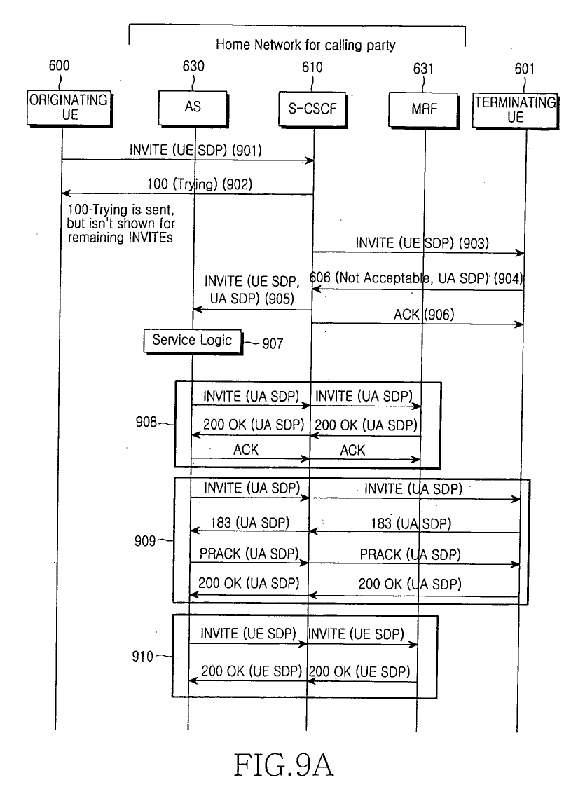

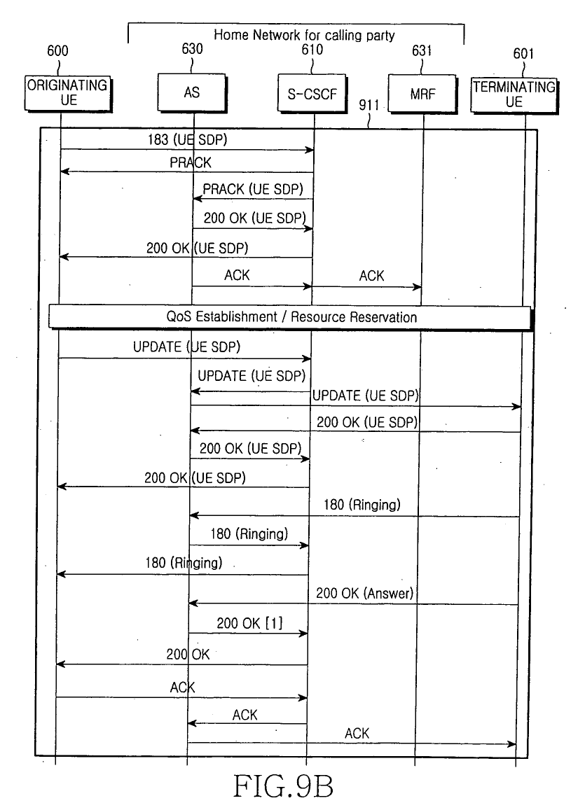

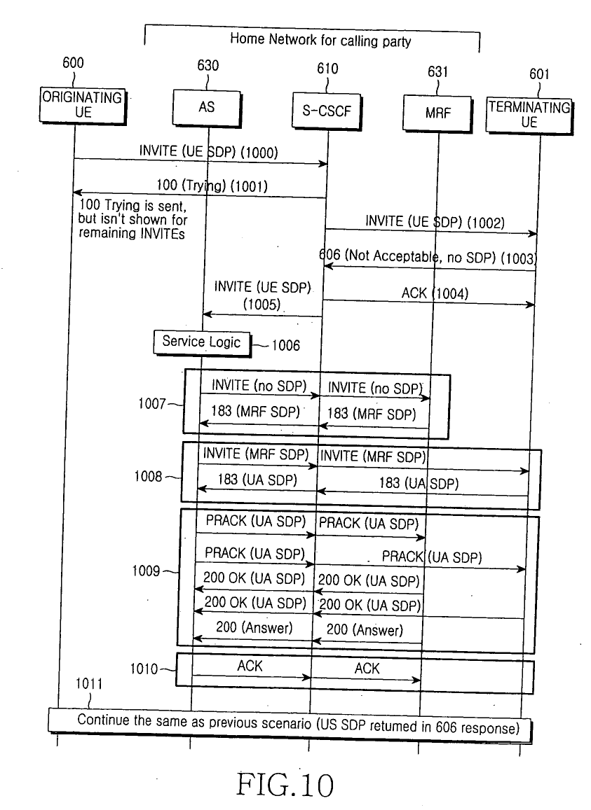

Meanwhile, FIGS. 9A, 9B, and 10 are views explaining a method for processing service triggering in an IP multimedia subsystem according to an exemplary embodiment of the present invention. A service triggering method using the proposed aFC will now be described with respect to transcoding, as an example, with reference to FIGS. 9A, 9B, and 10.

Transcoding is required when a user equipment located in an A IMS network 640 and a user equipment located in a B IMS network 660 communicate with each other, in which a originating-party IMS user equipment and a terminating-party IMS user equipment use different codecs.

The S-CSCF 610 according to an exemplary embodiment of the present invention can perform service triggering based on a 606 Not Acceptable message, other than an INVITE message, by means of the aFC 740. After the S-CSCF 610 transmits an INVITE message to the AS 630, which provides a service, the AS 630 transmits an INVITE message to the terminating user equipment 601 and then receives codec information from the terminating user equipment 601, so that a session is established between the MRF 631 and each user equipment.

The service triggering method in an IP multimedia subsystem according to an embodiment of the present invention will be described when an acceptable codec list is sent from a terminating user equipment as a response and when the codec list is not sent.

Before a call flow as described below, a user profile is downloaded from the HSS 620 to the S-CSCF 610. Also, the user profile is transmitted from the HSS 620 to the S-CSCF 610 upon registration. In addition, the user profile transmitted from the HSS 620 includes the aFC 740.

First, the following description will be given to explain when a terminating user equipment transmits a 606 Not Acceptable message including a terminating-party codec, with reference to FIGS. 9A and 9B.

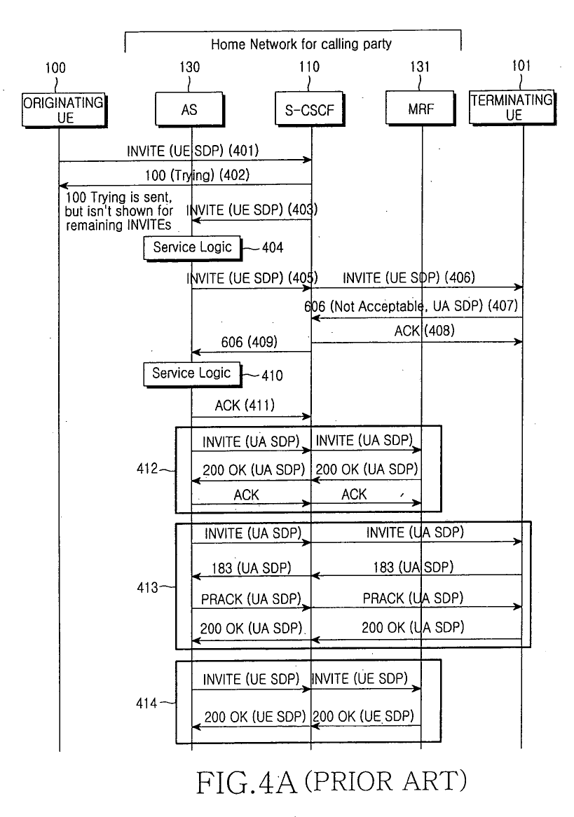

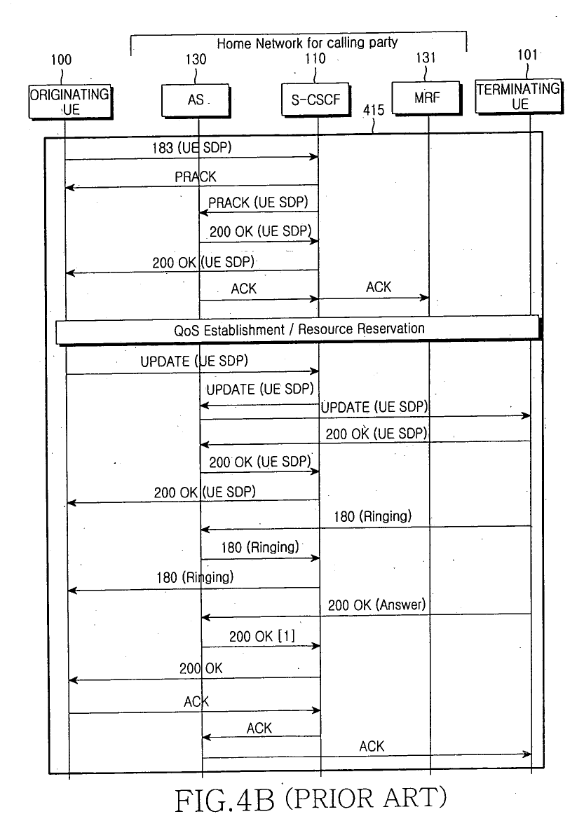

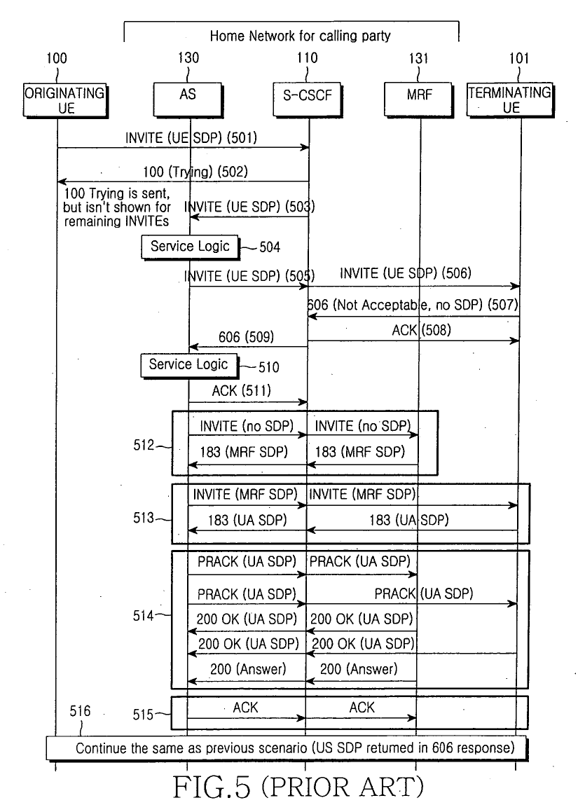

Steps 908 to 911 in FIGS. 9A and 9B are same as conventional steps 412 to 415 in FIGS. 4A and 4B. Therefore, the following description will be given with respect to certain exemplary embodiments of the present invention.

First, in step 901, an S-CSCF 610 receives an INVITE message from an originating user equipment 600. In an exemplary implementation, the INVITE message includes codec information (SDP) of the originating user equipment 600. In step 902, the S-CSCF 610 transmits a 100 Trying message to the originating user equipment 600. Thereafter, the transmission of the 100 Trying message is omitted. In step 903, the S-CSCF 610 transmits an INVITE message to a terminating user equipment 601. In step 904, the terminating user equipment 601 transmits a 606 Not Acceptable message to the S-CSCF 610, in response to the INVITE message. The 606 Not Acceptable message includes information representing that the codec transmitted from the originating user equipment 600 is not acceptable, and information regarding a codec which is acceptable by the terminating user equipment 601. Then, in order to determine if the 606 Not Acceptable message has been defined in aFC 740, the S-CSCF 610 checks all filter criteria included in the aFC 740. The S-CSCF 610 checks filter criteria for the 606 Not Acceptable message and checks an AS to which the S-CSCF 610 is to transmit a corresponding message after receiving the 606 Not Acceptable message, and then creates a new INVITE message based on the aFC 740 and transmits the new INVITE message to the AS 630 (step 905). In an exemplary implementation, the INVITE message includes both an SDP transmitted from the originating user equipment and an SDP transmitted from the terminating user equipment. In step 906, the S-CSCF 610 transmits an ACK message to the terminating user equipment 601 in order to end a dialog of Call-ID 1 transmitted to the terminating user equipment 601.

In step 907, the service logic 633 of the AS 630 determines if the corresponding INVITE message is to be processed, if a transcoding service has been requested, and if an MRF capable of performing transcoding exists. When an MRF which is to perform transcoding exists, the AS 630 transmits a new INVITE message to the MRF 631 in step 908 in order to establish a transcoding function for the terminating user equipment 601 [Call-ID 2], which is performed to transmit the terminating-party codec information (SDP) to the MRF 631. In step 909, the AS 630 transmits a new INVITE message to the terminating user equipment 601 in order to establish a session between the MRF 631 and the terminating user equipment 601 [Call-ID 3]. This is performed in order to again request a session to the terminating user equipment 601 because the S-CSCF 610 has received the 606 Not Acceptable message from the terminating user equipment 601 in step 904. In step 910, the AS 630 transmits a new INVITE message to the MRF 631 in order to establish a transcoding function for the originating user equipment 600 [Call-ID 4]. Step 911 in FIG. 9B represents a typical IMS call flow. The AS 630 operates in a back-to-back user agent (B2BUA) mode, and provides a signaling conversion function between relevant dialogs.

The following description will be given regarding the case in which codec negotiation is required because a terminating user equipment has not inserted a terminating-party codec into a 606 Not Acceptable message.

In step 1000, an S-CSCF 610 receives an INVITE message from an originating user equipment 600 [Call-ID 1]. In step 1001, the S-CSCF 610 transmits a 100 Trying message to the originating user equipment 600. In step 1002, the S-CSCF 610 transmits an INVITE message to the terminating user equipment 601. In step 1003, the terminating user equipment 601 transmits a 606 Not Acceptable message to the S-CSCF 610, in response to the INVITE message. The 606 Not Acceptable message includes information representing that the codec transmitted from the originating user equipment 600 is not acceptable, but does not include information regarding a codec which is acceptable by the terminating user equipment 601. That is, the INVITE message does not include an SDP. In step 1004, the S-CSCF 610 transmits an ACK message to the terminating user equipment 601 in order to end the dialog of Call-ID 1 transmitted to the terminating party. Thereafter, in step 1005, the S-CSCF 610 creates a new INVITE message based on aFC 740 and transmits the created INVITE message to the AS 630. The INVITE message includes an SDP transmitted from the originating user equipment 600, but does not include an SDP transmitted from the terminating user equipment 601. In step 1006, the service logic 633 of the AS 630 determines if the INVITE message is to be processed and determines if an MRF, which is to perform transcoding, exists.

When the service logic 633 determines that the INVITE message is to be processed and that an MRF exists, the AS 630 transmits a new INVITE message to the MRF 631, in order to establish a transcoding function for the terminating user equipment 601 and simultaneously to obtain codec list information (SDP) supported by the MRF 631 in step 1007 [Call-ID 2].

In step 1008, the AS 630 transmits a new INVITE message including a codec list, which has been provided from the MRF 631, to the terminating user equipment 601, in order to establish a session between the MRF 631 and the terminating user equipment 601 [Call-ID 3]. Then, the terminating user equipment 601 transmits an SDP including an acceptable codec list to the AS 630.

In step 1009, a codec list selected by the terminating user equipment 601 is carried by a PRACK message transmitted from the AS 630 to the MRF 631, and information regarding a finally-selected codec is carried by a 200 OK message transmitted from the MRF 631 to the AS 630.

In step 1010, the AS 630 transmits an ACK message to the MRF 631 in order to end the dialog of Call-ID 2.

The call setup procedure performed after step 1010 is the same as the procedure which proceeds after a 606 Not Acceptable message has been received in a transcoding call flow shown in FIG. 9B, that is, when a codec has been presented by the terminating user equipment.

Meanwhile, FIG. 11 is a flowchart illustrating the control operation of an S-CSCF when the S-CSCF performs service triggering according to an exemplary embodiment of the present invention. The operation of the S-CSCF using aFC will now be described with reference to the flowchart of FIG. 11. In step 1101, the S-CSCF 610 receives a message. The message includes an initial INVITE message and subsequently transmitted messages. Thereafter, in step 1102, the S-CSCF 610 determines if a service triggering count value is smaller than the restricted number of service triggering times. Step 1102 is a selectively used step, which can proceed only when the number of service triggering times, which is permitted during a call setup, is restricted. The initial value of the service trigging count is zero. When the service triggering count value is larger than or equal to the restricted number of service triggering times, the S-CSCF 610 proceeds to step 1109 of performing a typical call processing procedure. In contrast, the service triggering count value is smaller than the restricted number of service triggering times, the S-CSCF 610 proceeds to step 1103. In step 1103, the S-CSCF 610 determines if the transmitted message is identical to a service point trigger 830 included in the aFC information, by comparing the transmitted message with aFC. If the transmitted message is not identical to the service point trigger included in the aFC information, the S-CSCF 610 proceeds to step 1107. In contrast, when the transmitted message and the service point trigger 830 are identical to each other, the S-CSCF 610 proceeds to step 1104 of creating and transmitting a new message to a corresponding AS 630. This is because a session always starts by an INVITE message. That is, when service triggering is generated based on a 183 message, a PRACK message, and the like, other than an initial INVITE message, it is possible to transmit a corresponding message to the AS 630, in order to create a new INVITE message. Thereafter, in step 1105, the S-CSCF 610 determines if there is a different re-action, other than transmitting the new INVITE message. When there is no different re-action, the S-CSCF 610 proceeds to step 1107, and when there is a different re-action, the S-CSCF 610 proceeds to step 1106 of performing a defined re-action. According to the service triggering structure proposed in the present invention, aFC 740 and sFC 750 may be used together. In an exemplary implementation, changing a setup state to process the aFC 740 when a service progresses by a specific SPT may be a “re-action”.

Meanwhile, in step 1107, the S-CSCF 610 determines if the transmitted message is compared with every trigger point. The aFC 740 shown in FIG. 8 has at least one trigger point 840, which has at least one service point trigger 830. Therefore, in step 1107, the S-CSCF 610 determines if the transmitted message is compared with every service point trigger 830 included in the trigger point 840 in the step of comparing the transmitted message with the service point trigger 830.

When the transmitted message is not compared with every service point trigger 830, the S-CSCF 610 returns to step 1103. In contrast, when the transmitted message is compared with every service point trigger 830, the S-CSCF 610 proceeds to step 1108 of increasing the service triggering count value. Thereafter, the S-CSCF 610 performs the typical call processing procedure.

Effects of certain exemplary embodiments of the present invention, especially the effects obtained by the above-mentioned exemplary embodiments, will now be described.

According to an exemplary embodiment of the present invention, when service triggering is performed in an IMS network, the S-CSCF can perform service triggering based on an initial INVITE message and subsequently transmitted messages.

In addition, according to certain exemplary embodiments of the present invention, in a specific service (for example, transcoding) in which it is determined by negotiation between an originating user equipment and a terminating user equipment whether the service is to be provided, the S-CSCF transmits an INVITE message to the AS based on a response of the terminating user equipment, instead of transmitting the INVITE message to the AS unconditionally regardless of service performance, so that it is possible to request a specific service.

While the present invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A system for processing service triggering in an Internet protocol (IP) multimedia subsystem, the system comprising:
a call session control function (CSCF) for processing service triggering based on messages, to which filter criteria (FC) information required for the service triggering is applied, upon a call setup;
a home subscriber server (HSS) for providing the filter criteria to the call session control function upon registration of a subscriber;
an application server for performing a call processing for providing a transcoding service, when an originating user equipment and a terminating user equipment use different codecs; and
a media resource function for performing a transcoding operation in accordance with different codecs between the originating user equipment and the terminating user equipment.

2. The system as claimed in claim 1, wherein the filter criteria correspond to any filter criteria (aFC).

3. The system as claimed in claim 2, wherein said aFC comprises triggering criteria for a specific service by means of a service point trigger comprising a session initiation protocol (SIP) message comprising an SIP method, existence of a specific header, contents of a specific header, and information regarding a time point for service triggering.

4. The system as claimed in claim 1, wherein the call session control function receives an INVITE message comprising codec information of the originating user equipment from the originating user equipment and then transmits the received INVITE message to the terminating user equipment,
determines a time point for service triggering and an application server in which a new INVITE message is to be transmitted, when receiving a message comprising information that the codec information of the originating user equipment is unacceptable and does not comprise codec information of the terminating user equipment from the terminating user equipment, and
transmits the new INVITE message to an application server according to a result of the determination, thereby triggering a service.

5. The system as claimed in claim 1, wherein the call session control function receives an INVITE message comprising codec information of the originating user equipment from the originating user equipment and then transmits the received INVITE message to the terminating user equipment,
determines a time point for service triggering and an application server in order to transmit a new INVITE message to the application server, when receiving a message comprising information that the codec information of the originating user equipment is unacceptable and codec information of the terminating user equipment from the terminating user equipment, and
transmits the new INVITE message to an application server according to a result of the determination, thereby triggering a service.

6. The system as claimed in claim 4, wherein, after receiving the new INVITE message from the home session control function, the application server transmits an INVITE message to the terminating user equipment to receive the codec information of the terminating user equipment, and establishes a session between the media resource function and each user equipment.

7. The system as claimed in claim 5, wherein, after receiving the new INVITE message from the home session control function, the application server establishes a session between the media resource function and each user equipment.

8. The system as claimed in claim 1, wherein, when any filter criteria (aFC) and subsequent filter criteria (sFC) are simultaneously applied, the call session control function primarily processes filter criteria comprising a higher priority.

9. A method for processing service triggering in an Internet protocol (IP) multimedia subsystem, the method comprising the step of:
receiving, by a call session control function, an INVITE message comprising codec information of an originating user equipment from the originating user equipment, and transmitting the INVITE message to a terminating user equipment;
determining if filter criteria are applied to a message, comprising information that the codec information of the originating user equipment is unacceptable and codec information of the terminating user equipment, when the message is received from the terminating user equipment; and
triggering a service by transmitting a new INVITE message to an application server, when the received message corresponds to a message to which filter criteria are applied.

10. The method as claimed in claim 9, wherein the filter criteria correspond to any filter criteria (aFC).

11. The method as claimed in claim 10, wherein said aFC comprises triggering criteria for a specific service by means of a service point trigger comprising a session initiation protocol (SIP) message, which comprises an SIP method, existence of a specific header, contents of a specific header, and information regarding a time point for service triggering.

12. The method as claimed in claim 9, wherein the step of triggering a service comprises:
determining a time point for service triggering and an application server in which a new INVITE message is to be transmitted, when receiving a message comprising information that the codec information of the originating user equipment is unacceptable and codec information of the terminating user equipment from the terminating user equipment, and
triggering a service by transmitting the new INVITE message to an application server according to a result of the determination.

13. The method as claimed in claim 9, wherein the step of triggering a service comprises:
determining a time point for service triggering and an application server in which a new INVITE message is to be transmitted, when receiving a message comprising information that the codec information of the originating user equipment is unacceptable and does not comprise codec information of the terminating user equipment, from the terminating user equipment, and
triggering a service by transmitting the new INVITE message to an application server according to a result of the determination.

14. The method as claimed in claim 9, further comprising establishing, by the application server, a session between a media resource function and each user equipment, after the step of triggering a service.

15. The method as claimed in claim 13, further comprising a step of transmitting, by the application server, an INVITE message to the terminating user equipment to receive the codec information of the terminating user equipment and then establishing a session between a media resource function and each user equipment, after the step of triggering a service.

16. An apparatus for processing service triggering in a call session control function of an Internet protocol (IP) multimedia subsystem, the apparatus comprising:
a filtering and service triggering unit for performing a filtering operation in accordance with a message by using filter criteria information transmitted from a home subscriber server when receiving the message during a call setup, and for determining if it is necessary to provide a specific service in accordance with a corresponding call setup request; and
a service triggering counter for increasing a count value whenever service triggering is performed in order to restrict a number of service triggering times of the filtering and service triggering unit.

17. The apparatus as claimed in claim 16, wherein the filtering and service triggering unit requests a call setup to an application server which provides a corresponding service, when a determination is made that a specific service is to be provided in accordance with the corresponding call setup request.

18. The apparatus as claimed in claim 16, wherein the filter criteria correspond to any filter criteria (aFC).

19. The apparatus as claimed in claim 18, wherein said aFC comprises criteria for triggering a specific service, by means of a service point trigger comprising a session initiation protocol (SIP) message, which contains an SIP method, existence of a specific header, contents of a specific header, and information regarding a time point for service triggering.

20. A method for processing service triggering in a call session control function of an Internet protocol (IP) multimedia subsystem, the method comprising the steps of:
determining if a service point trigger of a received message and filter criteria information received from a home subscriber server during a call setup are identical to each other; and
creating and transmitting a new INVITE message to an application server, when the service point trigger of the received message and the filter criteria are identical to each other.

21. The method as claimed in claim 20, wherein the filter criteria correspond to any filter criteria (aFC).

22. The method as claimed in claim 21, wherein said aFC comprises criteria for triggering a specific service, by a service point trigger comprising an SIP message, which contains an SIP method, existence of a specific header, contents of a specific header, and information regarding a time point for service triggering.

23. The method as claimed in claim 20, further comprising the steps of:
determining if a service triggering count value is smaller than a restricted number of service triggering times; and
determining if a service point trigger of a message received from a terminating user equipment and filter criteria information received from the home subscriber server during a call setup are identical to each other, when the service triggering count value is smaller than the restricted number of service triggering times.

24. The method as claimed in claim 20, further comprising the steps of:
determining if a re-action exists, other than transmission of the new INVITE message;
performing the re-action when the re-action exists;
determining if comparison for every service point triggering in a trigger point has been performed; and
increasing a service triggering count value when every service point triggering is compared.

25. The method as claimed in claim 24, wherein the re-action comprises changing an establishment to process only aFC when a service progresses by a specific service point triggering (SPT) in which aFC and subsequent filter criteria (sFC) are used together.

26. A system for processing service triggering in an Internet protocol (IP) multimedia subsystem, the system comprising:
a call session control function (CSCF) for processing service triggering based on messages, to which filter criteria (FC) information required for the service triggering is applied, upon a call setup;
a home subscriber server (HSS) for providing the filter criteria to the call session control function upon registration of a subscriber.

27. The system as claimed in claim 26, wherein the filter criteria correspond to any filter criteria (aFC).

28. The system as claimed in claim 27, wherein said aFC comprises triggering criteria for a specific service by means of a service point trigger comprising a session initiation protocol (SIP) message comprising an SIP method, existence of a specific header, contents of a specific header, and information regarding a time point for service triggering.
